(19) United States
(12) Patent Application Publication
(10) Pub. No.: US 2013/0332239 A1
(43) Pub. Date: Dec. 12, 2013

(54) DISPENSATION SYSTEM

(71) Applicant: Daniel A. Matre, Brookfield, WI (US)

(72) Inventor: Daniel A. Matre, Brookfield, WI (US)

(21) Appl. No.: 13/914,835

(22) Filed: Jun. 11, 2013

Related U.S. Application Data
(60) Provisional application No. 61/658,675, filed on Jun. 12, 2012.

(51) Int. Cl. G06Q 30/02

(52) U.S. Cl. CPC G06Q 30/0206
USPC 705/7.35; 700/232

(57) ABSTRACT

A dispensation system is provided that may allow for dispensing treated water from an on-site treated water device directly to reusable containers used by customers at reduced or no cost to the customers. Particular costs of the treated water to the customers may be based on the customers' willingness to provide information through the dispensation system. The cost to a particular customer and the amount of information shared by that customer may be inversely related. The information may relate to purchasing preferences or other lifestyle information about the customer. The dispensation system may share the information with an advertiser that pays to present targeted advertising to the customer, for example, through video advertising at the dispensation system while the customer uses the dispensing system.

### CROSS REFERENCE TO RELATED APPLICATION

This application claims the benefit of U.S. Provisional Patent App. No. 61/658,675 filed on Feb. Jun. 12, 2012.

### FIELD OF THE INVENTION

The present invention relates generally to dispensing systems and, in particular, to systems for dispensing treated water.

### BACKGROUND OF THE INVENTION

People are becoming increasingly aware of the importance of consuming water regularly throughout the day. Along with this awareness, purchasing treated water in disposable plastic bottles has increased in popularity. This increased consumption of treated water from disposable plastic bottles brings with it an increase in the amount of plastic material that requires disposal. Corresponding concerns have been raised about the waste and non-sustainability of the use of disposable plastic bottles for distribution of potable drinking water. Certain communities, colleges and universities have legislated rules, regulations and laws banning bottled water to try reducing the amount of used plastic bottles that require disposal. Some efforts have been made to reduce the use of bottled water by providing treated water devices that can dispense treated water on-site into reusable containers. However, these treated water devices are expensive to initially purchase and require substantial ongoing costs to operate because, for example, they use expensive consumables such as water filters.

### SUMMARY OF THE INVENTION

The present invention relates to a dispensation system that may facilitate use of reusable containers in preference to plastic containers that require disposal.

According to one aspect of the invention, a dispensation system is provided that may provide on-site treated water dispensed into a reusable container of a customer at a variable cost purchase price that is controlled by the customer. A particular purchase price of the treated water may range between a full retail price to free of charge, depending on how much lifestyle information the customer provides to the dispensation system. This may encourage use of refillable containers for receiving treated water, instead of using disposable plastic bottles that are prefilled with treated water.

According to another aspect of the invention, a dispensation system may allow for dispensing treated water from an on-site treated water device directly to reusable containers used by customers at reduced or no cost to the customers. Particular costs of the treated water to the customers may be based on the customers' willingness to provide information through the dispensation system. The cost to a particular customer and the amount of information shared by that customer may be inversely related. The information may relate to purchasing preferences or other lifestyle information about the customer. The dispensation system may share the information with an advertiser that pays to present targeted advertising to the customer, for example, through video advertising at the dispensation system while the customer uses the dispensing system.

According to another aspect of the invention, a method may be provided for dispensing treated water. The method may include providing user information of a customer to a dispensation system. The dispensation system may include a treated water dispenser for on-site dispensing of treated water during a dispensing event. A purchase price may be determined for the treated water dispensed during the dispensing event based at least in part on the user information provided to the dispensation system. A determination may be made relating to displayed content to be displayed during the dispensing event based at least in part on the user information provided to the dispensation system. The customer is charged for the purchase price of the treated water and the displayed content is displayed for viewing by the customer.

According to another aspect of the invention, the displayed content includes advertising content. An amount of advertising content displayed during the dispensing event may be based at least in part on the user information provided to the dispensation system. A subject matter of advertising content displayed during the dispensing event may be based at least in part on the user information provided to the dispensation system. The user information may include lifestyle information of the customer.

According to another aspect of the invention, the purchase price may be inversely related to an amount of user information provided by the customer. The purchase price may be a full retail price when no user information is provided by the customer or free of charge price when a complete set of user information is provided by the customer. The purchase price may correspond to a discounted price when a partial set of user information is provided by the customer.

According to another aspect of the invention, the user information may be provided through a user input interface of the dispensation system. The user information may be provided during an initial use of the dispensation system. The customer may provide different user information during a subsequent use of the dispensation system. The different user information may include a different subject matter of a lifestyle preference of the customer. The different displayed content may be displayed during a subsequent dispensing event corresponding to the different user information provided by the customer during the subsequent dispensing event. The different user information may include a different amount of user information. The customer may be charged a different purchase price for the treated water based on the different amount of user information. This may allow a customer to change the type or amount of advertising or change the purchase price, based on the customer's preference at a given time.

According to another aspect of the invention, a system is provided that may disseminate a consumable good, e.g., treated water, to customers, e.g., into reusable containers, while integrating such dissemination with broadcasting of video and/or audio data to customers. Generally speaking, the system for integrated treated water and data distribution (“system”) may include various interconnected subassemblies including video monitor, water dispenser, controller, power manager, lower cover and a variety of user inputs. Users are further defined as customers, advertisers and hosts.

According to another aspect of the invention, the customer may create a prepaid account with a corresponding access code that when entered into a control panel dispenses a measured amount of treated water into the customer's reusable container. The cost of the treated water to the customer would be determined on an inverse scale relative to the amount of lifestyle information the customer is willing to share with the controlling entity. For example, if a customer offers no life style information the cost of the treated water to the customer would be 100% of the established sell price. Another example would be if the customer offers a certain amount of lifestyle information the cost of the treated water to the customer would be 0% of the established sell price. Having lifestyle information about customers would increase the value of the advertising broadcast via the monitor resulting in increased cash flows with a portion being shared with the host.

According to another aspect of the invention, the water dispenser, video display and input devices may all be interconnected with a controller that is also connected, directly or indirectly, to the controlling entity. The controller monitors the status of a variety of components for real time evaluation and reaction by the hosting entity. For example, after a predetermined amount of water is dispensed, the controller would send a signal to the controlling entity that the filter needs to be replaced with a new filter. The customer input components may include paper cash and/or coins, card swiping, proximity devices, access code entry via a variety of key board types, and remote input via portable electronic devices and assorted software applications.

According to another aspect of the invention, a method is provided for dispensing a product and may include providing a dispensation assembly including a dispenser and a display. A controller is provided that communicates with the dispensation assembly. Information is gathered from users of the dispensation assembly. A particular user is identified when the particular user accesses the dispenser. Content is displayed on the display corresponding to an aspect of a particular user's information when the particular user accesses the dispenser.

According to another aspect of the invention, the computer system may be used to store and access the information. The computer system may be in communication with the controller or the controller may define part of the computer system. An identifier may be assigned to each user of the dispenser. Information from the users may be gathered through a website.

According to another aspect of the invention, the dispensation system is configured for dispensing water, and may replace existing drinking fountains by retrofitting or may be installed in new locations within an establishment or included with new construction. In addition to permanent installation, the system may be portable. The video monitor broadcasts a wide array of information that may be of value to customers simultaneous with receiving treated water from the system. The controlling entity would be the centralized operator of the system with the host, advertisers, and customers having varying degrees of direct and indirect connection to the video monitors. The water dispenser may filter, chill, and add other optional ingredients to water for use by the customer. For example; flavors or other ingredients, singularly or in combinations, may be added to the water.

Various other features, objects, and advantages of the invention will be made apparent from the following description taken together with the drawings.

### BRIEF DESCRIPTION OF THE DRAWINGS

FIG. 1 is an isometric view of one embodiment of the system for integrated treated water and data distribution;

FIG. 2 is an isometric view of the video monitor and upper assembly;

FIG. 3 is an isometric view of one embodiment of user input;

FIG. 4 is an isometric view of the dispenser and reusable container;

FIG. 5 is a schematic diagram of one embodiment of the system for integrated treated water and data distribution; and

FIG. 6 is a flow chart showing a method of dispensing a consumable product.

FIG. 7 is a flow chart showing a variant of the method of FIG. 6.

### DETAILED DESCRIPTION

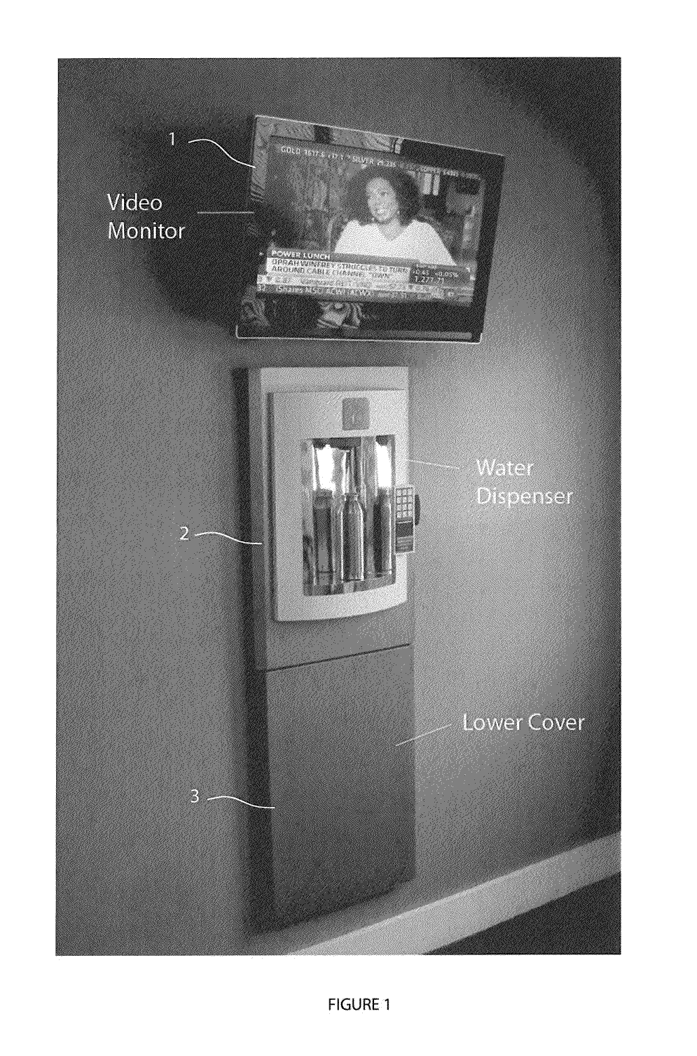

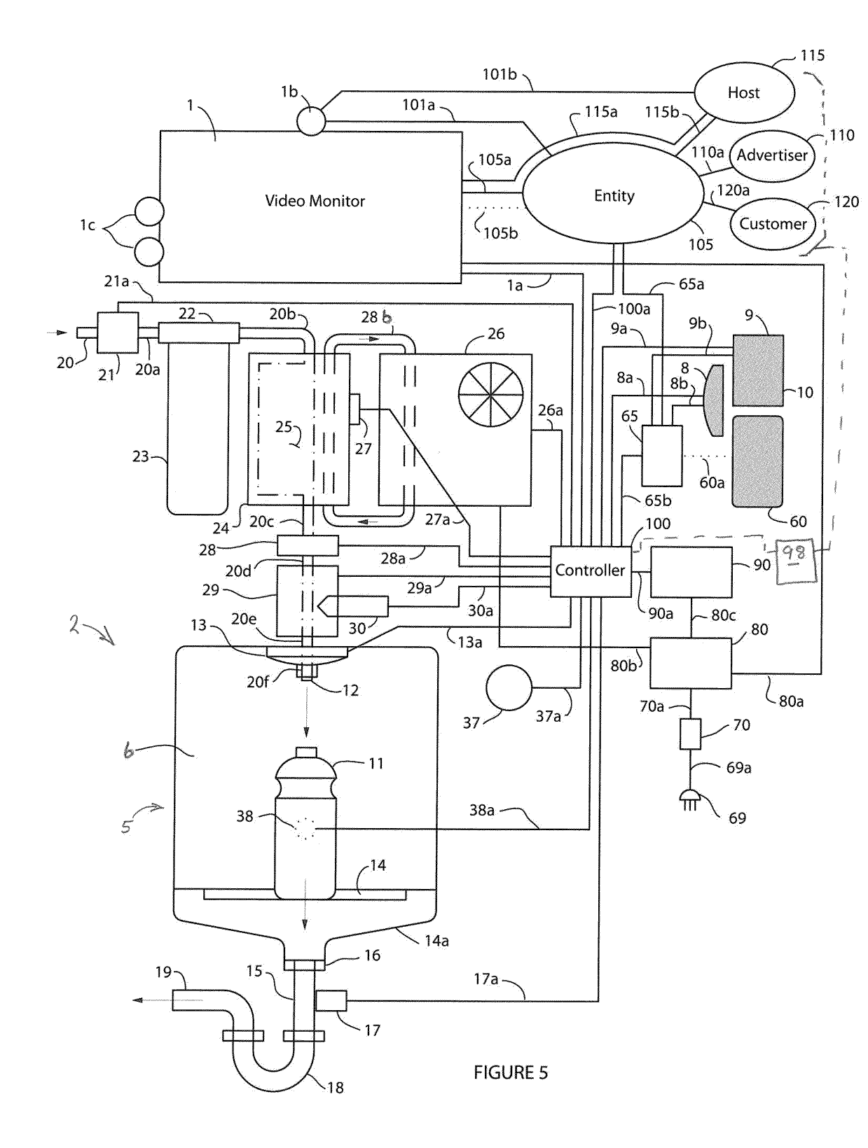

FIGS. 1 and 5 illustrate a dispensation system that is configured to facilitate use of reusable containers in preference to plastic containers that require disposal. In representative use applications, the dispensation system is shown in the context of a water dispenser dispensing treated water. However, it is understood that the dispensation system may be used for dispensing a variety of other consumable goods, such as goods that may be purchased from conventional vending machines. Referring now to FIGS. 1-5, the system includes various subassemblies that are operably connected to each other. The subassemblies include a display 1, shown as a video monitor 1, a water dispenser 2, a controller 100, a power manager (not shown) for supplying and/or conditioning of both high and low voltage electrical demands of the system, and a variety of user inputs that are interconnected with each other by way of various conductors or other components, explained in greater detail elsewhere herein.

Referring now to Referring now to FIGS. 1-4, the water dispenser 2 may include lower and upper covers 3 and 4 that at least partially define an enclosure 5. Although water dispenser 2 and video monitor 1 are shown in this embodiment as separate from each other, it is understood that the video monitor 1 may be embedded within or integral to the water dispenser 2, such as housed within the enclosure 5 so as to be visible by a customer. A vestibule 6 is defined in the water dispenser 2 for receiving a reusable container 11 that can be filled with the treated water through a dispensing nozzle 12, which may be a laminar dispensing nozzle. Dispensing through the dispensing nozzle 12 at the vestibule 6 may be at least partially controlled through customer input station 7.

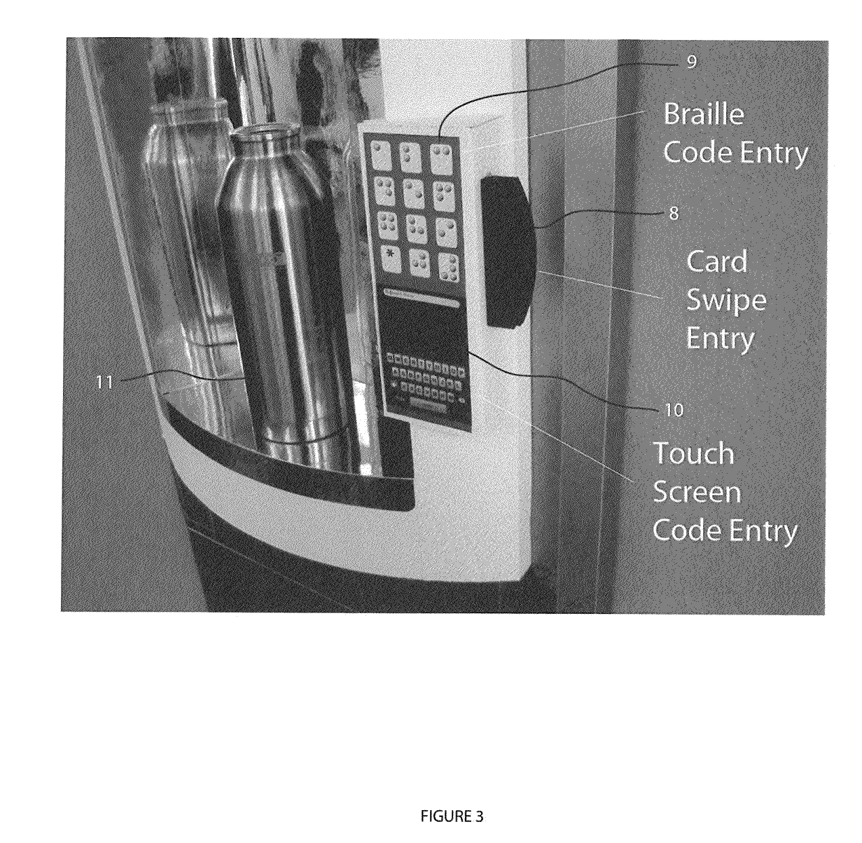

Referring now to FIGS. 3 and 5, customer input station 7 is arranged with respect to the water dispenser 2 to allow for convenient entry of information and/or payment to the system, by the customer. In this embodiment, customer input station 7 includes a card swipe device 8 which is a card reader configured to read a card, e.g., a magnetic strip card, for payment or to convey of other user information. Card swipe device 8 is operably connected to controller 100 by communications line 8a and/or to controller 100. Communications line 8b may connect the card swipe device 8 to a transceiver 65 that connects to the controller 100 by way of communications, line 65b. An alpha numeric keyboard 9 may offer traditional mechanical entry conducive to Braille enhanced keys for visually impaired customers 120. An alpha numeric key pad 10 may include a touch screen, allowing input of user information. The alpha numeric keyboard and key pad 9, 10 are operably connected to the controller 100 or other components via a communications lines 9a and/or to controller 100 through transceiver 65 and communication lines 9b and 65b.

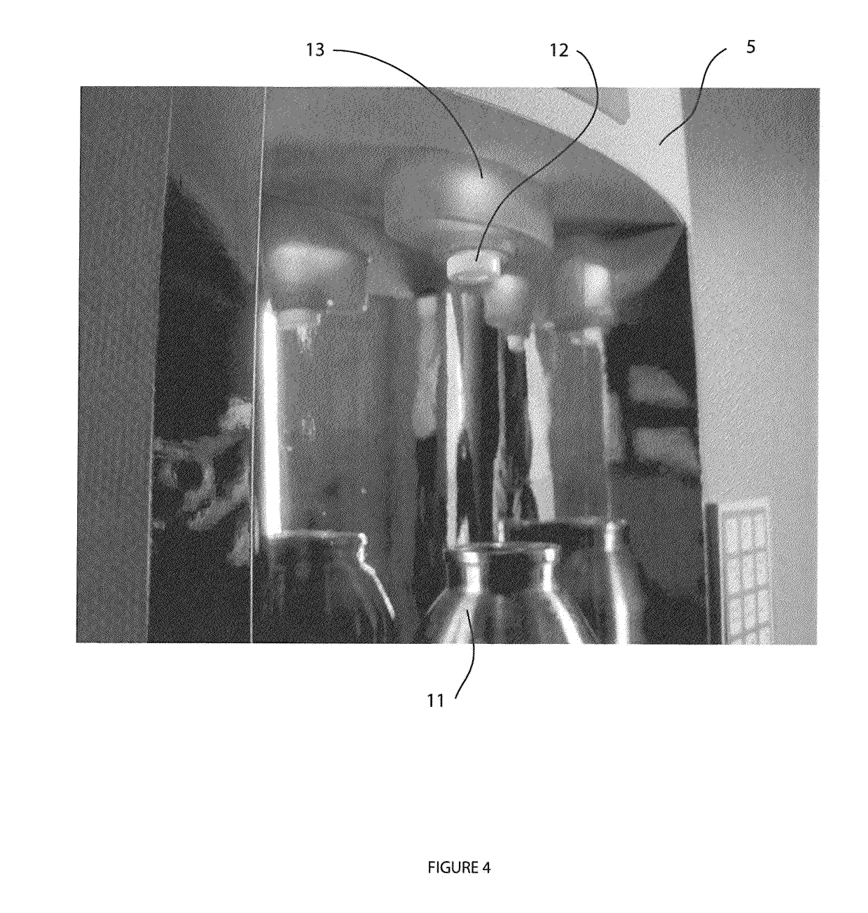

Referring now to FIGS. 4 and 5, the water dispenser 2 may include an ultraviolet lamp assembly 13 that may sanitize objects within a line of sight, such as reusable container 11 during a dispensing event. Referring now to FIG. 5, during the dispensing event, the reusable container 11 is supported by a shelf 14 of the vestibule 6 that defines a depressed plane of a basin 14a that is arranged to receive excess treated water that may spill out of the reusable container 11 during the dispensing event. Such spilled water is directed out of the basin 14a through tail pipe 15 at which a fluid sensor 17 may be arranged to detect presence of standing water in the tailpipe 15 and a corresponding clogged condition of the plumbing and transmit a corresponding signal to the controller 100 and through communications line 17a for display of an massage at the water dispenser 2 relating to the clogged condition. Various plumbing connectors or fittings interconnect the basin 14a, tail pipe 15, and a downstream p-trap 18 and waste pipe 19 and/or other components to each other for connecting the water dispenser 2 to the plumbing system of a host facility such as a building in which the water dispenser 2 is installed.

Referring still to FIG. 5, untreated water from the host facility enters the water dispenser 2 via an untreated water inlet 20. A combination inlet valve with pressure sensor 21 controls and monitors the flow of untreated water and/or sends signals corresponding to the same via the communications line 21a that connects to the controller 100. Water pipe 20a directs water from the water in the 20 or pressure sensor 21 to a manifold 22 that diverts the untreated water through one or more linear or parallel filter(s) 23. Filtered water then exits the manifold 22 traveling through a water pipe 20b to a cooler 24. The cooler 24 includes a cavity 25 consisting of a void or serpentine pathway that cools filtered water for exit via the water pipe 20c. The cooler 24 removes heat from the filtered water via thermal differential created by a compressor 26. The compressor 26 delivers a chilled coolant to the cooler 24 via a recirculation coolant pipe 28b. The proper temperature of the cooler 24 and filtered water is monitored by a thermal sensor 27. The thermal sensor 27 is connected to the controller 100 via a communications line 27a providing signals to the compressor 26 regarding the proper amounts of coolant to be delivered to the cooler 24 via the re-circulating coolant pipe 28b. Filtered and chilled water exits the cooler 24 via a water pipe 20c. A water valve 28 includes an activator or actuator, e.g., a solenoid actuator, which opens and closes a metered orifice resulting in the release of measures amounts of filtered and chilled water to the mixing manifold 29. The water valve 28 is connected to the controller 100 via communications line 28a. The filtered and chilled water may travel unimpeded to the laminar dispensing nozzle 12 or further treated by one or more injectors 30. For example; a flavor, mix of flavors, or caffeine may be added to the filtered, chilled measured amount of treated water being dispensed into a reusable container 11. The injector(s) 30 may be connected to the controller 100 via a communication line 30a.

Still referring to FIG. 5, a speaker 37 may be connected to the controller 100 with communications lines 37a for conveying audible information to the customer. A proximity switch 38 may be arranged within the vestibule 6 to ensure that a reusable container 11 is in place before allowing the water dispenser 2 to dispense a predetermined such as a measured amount of final treated water into the reusable container 11. The proximity switch 38 is connected to the controller 100 via a communications line 38a.

Still referring to FIG. 5, in this embodiment, the system is configured to allow portable electronic devices 60, including smart phones, to be usable as the customer input station 7, or to perform at least some of the functions of the customer input station 7. The portable electronic devices 60 in this embodiment defines a wireless communications connection 60a with the transceiver 65 and thus the controller 100 by way of communications line 65b to facilitate providing user information to the system and/or activate dispensing of final treated water.

Still referring to FIG. 5, an electrical connection 69 which may be a three prong plug type or hard wired type connects the system to the electrical system of the host facility for delivering electrical power to the system. A power line 69a connects the connection 69 to a ground fault circuit interrupter 70. Power line 70a connects the ground fault circuit interrupter 70 to a surge protector 80. Power lines 80a, 80b, and 80c connect the surge protector 80 to video monitor 1, compressor 26, and a transformer 90, respectively. The transformer 90 converts high voltage power to low voltage power for use by various components of the system. The transformer 90 may be integrated into the controller 100 or maybe separate from and connected to the controller by power line 90a, as shown.

Still referring to FIG. 5, a computer system 98 is operably connected to the system. Computer system 98 may communicate with the controller 100 or the controller 100 may be at least partially defined within the computer system 98. The computer system 98 includes one or more computers that may include or be coupled to at least one memory medium that may store program instructions for achieving the present functions of the system and can be understood to include one or more controllers or microprocessors that can communicate in a stand-alone and/or distributed or networked environment(s). The controller 100 can include an industrial computer or, e.g., a programmable logic controller (PLC), along with corresponding software and suitable memory for storing such software and hardware including interconnecting conductors for power and signal transmission for controlling electronic or electro-mechanical components of the video monitor 1 and water dispenser 2, which may include controlling content and duration of play of the display content, payment transactions, processing of user input information, and volume and other dispensing characteristics of the dispensed treated water. The controller 100 is connected to an entity 105 via the communications line 100a. In one embodiment, the controller 100 is configured to monitor and control the components of the system and communicates with entity 105. Connections and resultant communications between the controller 100 and the entity 105 may be two-way. Connections between the controller 100 and other components in the system may be two-way. For example, the controller 100 may provide low voltage power via the communication line 28a to the water valve 28 to operate an embedded electromagnetic solenoid while simultaneously sending a communication to open the valve 28 for a specified amount of time. After the specified amount of time is elapsed, the controller would send a communication for the embedded electromagnet solenoid to close the valve 28. The valve 28 may also send a signal to the controller 100 as to its open or closed status. The software of the controller 100 may be stored in memory of the controller 100 itself, may be stored by the entity 105, or elsewhere on the computer system 98. The controller 100 may be located within the water dispenser 2 or be remotely located within the entity 105.

Still referring to FIG. 5, content to be displayed on video monitor 1 may be stored on and/or provided by the computer system 98, controller 100, or the entity 105. In this way, the content to be displayed may be video content provided by, for example, the entity 105 that connects to the video monitor 1 by communications line 105a and/or a wireless communications line 105b. Entity 105 may also receive may provide real time imaging of the immediate environment by way of camera 1b that is connected to the entity 105 via a communications line 101a and a host 115, explained in greater detail elsewhere herein, via communications line 101b. Video content may also be provided by a third party, such as an advertiser 110 that connects to the entity 105 by way of communications line 110a. Host 115 is connected to video monitor 1 and entity 105 by communication lines 115a, 115b, respectively.

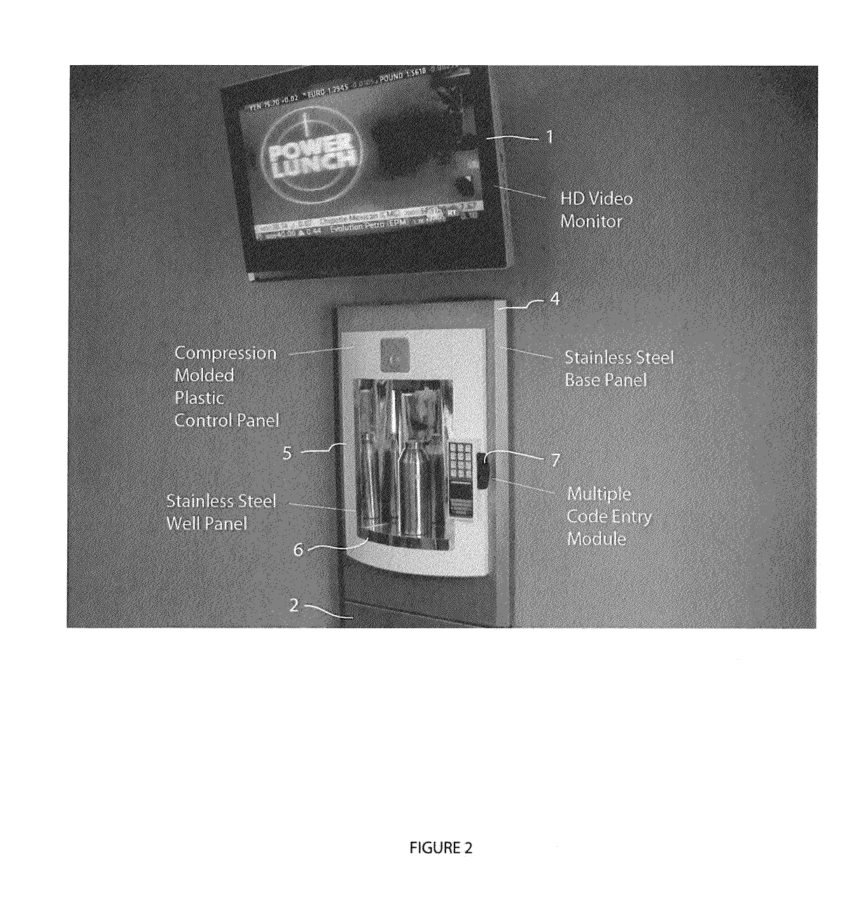

Referring now to FIGS. 2, 3, and 5, a customer 120 is offered an array of input modalities. The customer 120 may connect with the entity 105 via a variety of communication methods as represented by the communications line 120a. For example, the customer 120 may set up an individual account with the entity 105, pre-pay the account and be issued a user access code 120c. The access code 120c would serve to identify the particular customer 120. The entity 105 may receive and store information from the customer 120, e.g., the customer may submit information such as lifestyle information to the entity 105 via a website maintained by the entity 105 for some other third party such as a host 115) on a computer system connected to the Internet. Thus, when a particular customer 120 accesses the water dispenser 2, the entity 105 may broadcast content on the video monitor 1 that corresponds to the particular customer's interest. For example, for a customer 120 who has submitted information to the entity 105 identifying golf as an interest, the entity 105 may display content relating to golf on the video monitor 1 while that customer 120 is at the water dispenser 2. Such correlation between the interests of the customer 120 and the content broadcasted to the customer 120 may enhance value of video information broadcasted to the customer 120. In one embodiment, other entities or individuals may provide information to the system. For example, third party retailers may provide information (with the customer's permission) to the system. Thus, if a customer purchased golf equipment from a golf retailer, the golf retailer may communicate that purchase to the dispensation system.

Referring now to FIGS. 2 and 5, the controller 100 (FIG. 5) may also record the time at which a particular customer 120 uses the water dispenser 2 and video monitor 1, which may further enhance the value due to when specific video broadcasts would appear. More specifically, the entity 105 will be able to select a particular advertisement from an advertiser 110 that corresponds to the interests of a particular customer 120. Thus, the video information displayed while the customer 120 is using the water dispenser 2 is more likely to be of interest to the customer 120. Moreover, the flow rate at which the water is dispensed from the water dispenser 2 may be correlated to the display of the video information. For example, when the video information is a video advertisement, e.g., one or more commercials, the length of the video advertisement can be correlated to the amount of time it takes to dispense a predetermined amount of water. Thus, the video advertisement will end around the same time that the water dispenser 2 stops dispensing water.

Depending on the amount of lifestyle information the customer 120 offers to the entity 105, the sell price of the final treated water; as determined by the entity 105, could be reduced. The controller 100 communicates with entity 105 via any suitable means, e.g., the controller 100 may send data to and receive data from the entity 105 via the Internet. Specific to operating the water dispenser, the customer 120 may initiate the dispensing of final treated water into their reusable container 11 by entering their access code 120c via one of a variety of input options. The card swipe 8 may utilize any means to read a card, e.g., a magnetic strip card, to initiate dispensing and debit the prepaid account via the controller 100 being connected to the entity 105 by a communications line 9a. The alpha numeric keyboard 9 may offer traditional mechanical entry conducive to Braille enhanced keys for visually impaired customers 120. The alpha numeric key pad 10 may be a touch screen input connected to the controller 100 via a communications line 9b. Additionally, portable electronic devices 60 may activate dispensing of final treated water via wireless communications connection 60c connecting to a transceiver 65 that connects to the controller 100.

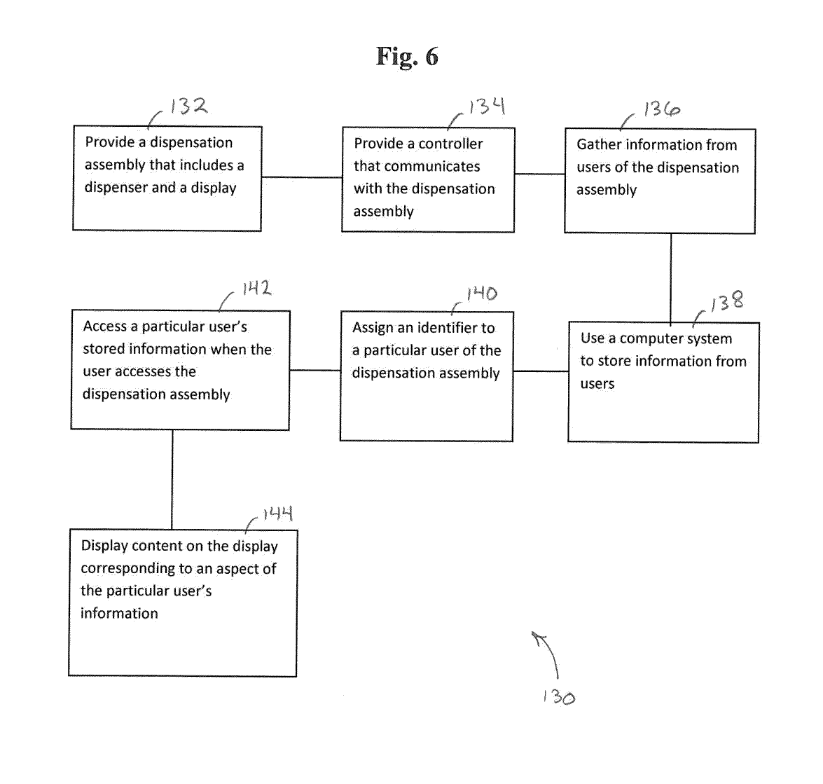

Referring now to FIG. 6, one embodiment of a representative method of using the system is schematically shown as indicated by arrow 130. The method may include dispensing a consumable product, such as water, to a consumer 120 while at the same time displaying content that corresponds to an interest of the customer 120. For example, if a particular customer 120 is interested in golf, the video monitor 1 may display content relating to golf while the customer 120 fills up a water bottle as a reusable container 11 at the dispenser 2.

As represented at block 132, a dispensation system, such as the one described above, is provided. The dispensation system may be provided wherever it is suitable to dispense a particular consumable product, and preferably it is provided at a location that is exposed to a large number of potential customers. For example, in the context of a water dispenser 2, the dispensation system may be provided on a college campus, e.g., in a student union building. Further, more than one dispensation assembly may be provided. For example, water dispensers may be provided throughout the college campus at locations where existing drinking fountains are in place.

As represented at block 134, the water dispenser 2 is in communication with a controller 100. Each water dispenser 2 may have a controller 100 specific to that assembly, or there may one controller 100 that controls multiple water dispensers 2. Regardless of the number of controllers 100 or the location of the controllers 100 (the controller may be at the location of the dispensation assembly or it may be remote with respect to the dispensation assembly), a controller 100 is provided, that communicates with the water dispenser 2.

As represented at block 136, the method further includes gathering information about customers 120 who use the dispensation system. For example, customers 120 may provide information via a Website, where the Website as various questions relating to the customer's interests. The information entered by the customer 120 may be stored by a computer system 98 that communicates with the controller 100, on the controller 100 itself, or elsewhere in the system, as represented at block 138. In another example, information pertaining to a particular customer 120 may be provided by a third party. For example, a retailer who sold golf equipment to a customer 120 may communicate that information, i.e., that the customer 120 purchased golf equipment, to the dispensation system. Thus, the purchasing history of particular customers may be submitted by third party retailers to the dispensation system.

As represented at block 140, a customer 120 may be assigned an identifier unique to that particular customer 120. Accordingly, the controller 100 and computer system 98 may quickly recall information pertaining to a particular user such as customer 120 when that particular customer, 120 accesses a dispenser 2. Once the information has been gathered and stored, it may be analyzed to determine various aspects of the customer information, e.g., such as the various interests of the customer 120. The computer system may then be used to correspond an aspect of the customer information, e.g., an interest in golf, to content that is displayed on the video monitor 1 when that particular customer 120 accesses the system. e.g., an advertisement for golf equipment. In other words, the computer system and/or controller correlate the content displayed on the video monitor to an interest of a particular customer 120.

As represented at block 142, when a customer 120 accesses the dispensation system, e.g., by inputting a credit card or a customer access code, the controller 100 and the computer system 98 cooperate to identify the customer 120, e.g., by associating the credit card or access code input by the customer 120 with an identifier assigned to the customer 120. Once the customer 120 is identified, the information pertaining to that particular customer 120 may be accessed on the computer system 98 and corresponding content may be displayed on the video monitor 1, as represented at block 144. The method may further include monitoring the frequency with which a particular customer 120 access the dispensation system, including the location of a particular dispenser 2 and the time at which the customer 120 accessed the dispenser 2. Such usage information may be communicated by the controller 100 to the computer system 98 and stored on the computer system 98.

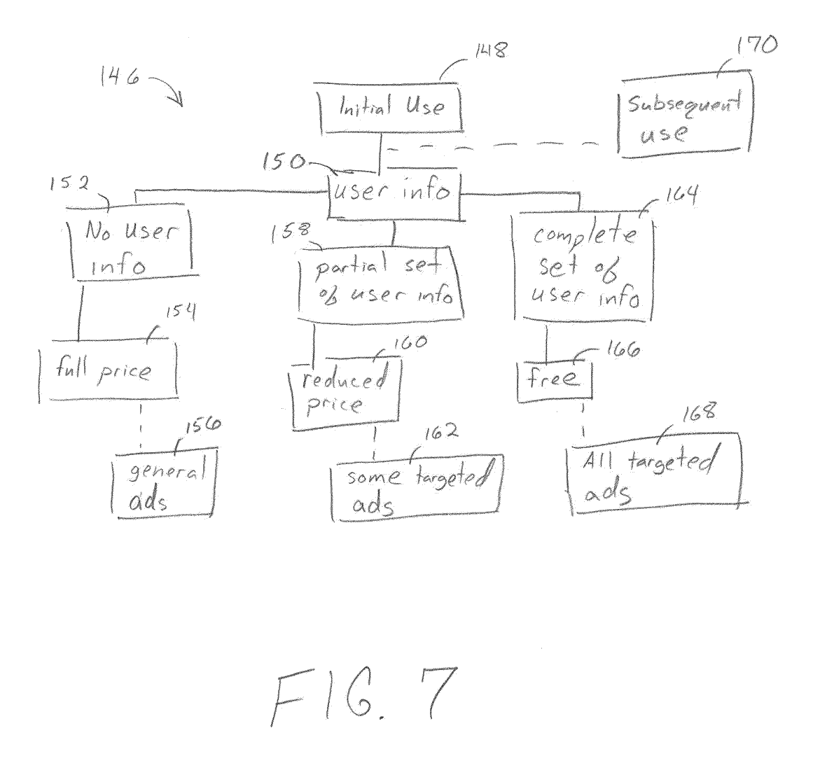

FIG. 7 shows another embodiment of a use of the invention, represented by arrow 146. As represented at block 148, customer 120 may perform an initial use of the system. User information may be provided through a user input interface of the dispensation system, such as through customer input station 7, as represented at block 150. The customer 120 may provide no user information to the system, as represented by block 152. Blocks 154 and 156 represent the customer 120 being charged full price for the dispensed treated water and viewing of general ads through the video monitor 1.

Still referring to FIG. 7, customer 120 may provide a partial set of user information by entering at least some information through customer input station 7, as represented at block 158. Blocks 160 and 162 show the customer 120 receiving a reduced price for the dispensed treated water and viewing of some targeted ads through the video monitor 1.

Still referring to FIG. 7, customer 120 may provide a complete set of user information by entering all requested information through customer input station 7, as represented at block 164. Blocks 166 and 168 show the customer 120 receiving the dispensed treated water for free and viewing all targeted ads through the video monitor 1. As represented at block 170, the customer 120 may change the type or amount of advertising and/or change the purchase price, based on the customer's 120 preference during a subsequent dispensing event.

It is specifically intended that the present invention not be limited to the embodiments and illustrations contained herein and the claims should be understood to include modified forms of those embodiments, including portions of the embodiments and combinations of elements of different embodiments as come within the scope of the following claims.

Various alternatives and embodiments are contemplated as being within the scope of the following claims particularly pointing out and distinctly claiming the subject matter regarded as the invention.

What is claimed is:

1. A dispensation system comprising:
a dispenser;
a display for displaying content;
a user input interface;
a controller that controls the dispenser and the display,
wherein when the user accesses the dispensation system the display displays content that corresponds to an interest of the user previously provided to the system.

2. The dispensation system of claim 1, further comprising a computer system that communicates with the controller for determining content to display.

3. The dispensation system of claim 2, wherein at least one of the computer system and the controller determines a purchase price for treated water dispensed from the dispenser based at least in part on an amount of user information provided to the dispensation system that corresponds to the interest of the user previously provided to the system.

4. The method of claim 3 wherein the content displayed on the display includes advertising comment and an amount of the advertising content corresponds to the amount of user information provided to the dispensation system.

5. A method of dispensing treated water, the method comprising:
providing user information of a customer to a dispensation system that includes a treated water dispenser for on-site dispensing of treated water during a dispensing event;
determining a purchase price for the treated water dispensed during the dispensing event based at least in part on the user information provided to the dispensation system;
determining displayed content to be displayed during the dispensing event based at least in part on the user information provided to the dispensation system;
charging the customer for the purchase price of the treated water;
displaying the displayed content for viewing by the customer.

6. The method of claim 5 wherein the displayed content includes advertising content.

7. The method of claim 6 wherein an amount of advertising content displayed during the dispensing event is based at least in part on the user information provided to the dispensation system.

8. The method of claim 6 wherein a subject matter of advertising content displayed during the dispensing event is based at least in part on the user information provided to the dispensation system.

9. The method of claim 6 wherein user information includes lifestyle information of the customer.

10. The method of claim 5 wherein the purchase price is inversely related to an amount of user information provided by the customer.

11. The method of claim 10 wherein the purchase price corresponds to a full retail price when no user information is provided by the customer.

12. The method of claim 10 wherein the purchase price corresponds to a free of charge price when a complete set of user information is provided by the customer.

13. The method of claim 10 wherein the purchase price corresponds to a discounted price when a partial set of user information is provided by the customer.

14. The method of claim 5 wherein the user information is provided through a user input interface of the dispensation system.

15. The method of claim 5 wherein the user information is provided during an initial use of the dispensation system.

16. The method of claim 15 wherein the customer provides different user information during a subsequent use of the dispensation system.

17. The method of claim 16 wherein the different user information includes a different subject matter of a lifestyle preference of the customer.

18. The method of claim 17 wherein different displayed content is displayed during a subsequent dispensing event corresponding to the different user information provided by the customer during the subsequent dispensing event.

19. The method of claim 15 wherein the different user information includes a different amount of user information.

20. The method of claim 19 wherein the customer is charged a different purchase price for the treated water based on the different amount of user information.
